(19) United States
(12) Patent Application Publication
(10) Pub. No.: US 2017/0343434 A1
(43) Pub. Date: Nov. 30, 2017

(54) SYSTEM & METHOD FOR MEASURING SUSPENSION TENSION

(71) Applicants: THYSSENKRUPP ELEVATOR AG, Essen (DE); THYSSENKRUPP AG, Essen (DE)

(72) Inventors: CHRISTIAN BREITE, ILMENAU (DE); MICHAEL BRAY, ELKHORN, NE (US); MICHAEL THUMM, STUTTGART (DE); JAMES MILLER WATTS, III, ATLANTA, GA (US); SHAWN PARK, ATLANTA, GA (US)

(21) Appl. No.: 15/163,067

(22) Filed: May 24, 2016

(51) Int. Cl. G01L 5/04; F16M 13/02; B66B 5/00

(52) U.S. Cl. CPC G01L 5/042; B66B 5/0018; F16M 13/02

(57) ABSTRACT

A system for determining tension in a suspended rope includes an acceleration measuring device for measuring the acceleration of rope movement and an adapter for attaching the acceleration measuring device to the suspended rope. The system optionally includes a user device communicatively coupled to the acceleration measuring device. The user device computes rope tension based on the measured acceleration. The acceleration measuring device and user device can be combined into a single smart device. Examples of the system can accurately determine the tension in ropes used to suspend an elevator cabin, allowing a field technician to tighten the ropes to equal tension and to determine the weight of the cabin. In turn, a smoother and more secure operation of the elevator can be achieved.

### BACKGROUND

Elevators have a common problem with unequally tensioned ropes, custom cabin designs that exceed maximum weight requirements, and excessive vibration of elevator cabins and other elevator components. These problems directly affect the ride quality and safety of the entire elevator system. Current solutions to these issues, however, are deficient because of their prohibitive size, weight, and expense.

### SUMMARY

In an embodiment, an adapter is provided. The adapter includes an elongated body extending between first and second ends. The body comprises a rope mounting side and a device mounting side. The rope mounting side has an open cavity extending between the first and second ends and is dimensioned to receive at least a portion of a rope. The device mounting side has a pair of opposing flanges projecting outwardly from the body. An opening between the flanges is dimensioned to receive at least a portion of an acceleration measuring device. The adapter further includes a first securing mechanism adapted to reversibly secure the portion of rope positioned within the cavity in contact with at least a portion of a surface defining the cavity such that the rope is substantially inhibited from moving with respect to the adapter body. The adapter also includes a second securing mechanism adapted to reversibly secure the portion of the acceleration measuring device positioned within the opening in contact with at least a portion of a surface of the opening such that the measurement device is substantially inhibited from moving with respect to the adapter body.

Embodiments of the adapter may include one or more of the following, in any combination.

In an embodiment of the adapter, the rope mounting side is positioned opposite the device mounting side of the adapter body.

In an embodiment of the adapter, the cavity possesses a V-shaped surface.

In an embodiment of the adapter, the securing mechanism includes a plurality of magnets positioned at the rope mounting side.

In an embodiment of the adapter, the first securing mechanism includes a plurality of ties dimensioned to wrap around the rope received within the cavity and attach to the rope mounting side such that the plurality of ties urges the rope into contact with the cavity surface.

In an embodiment, a system for measuring rope tension is provided. The system includes an adapter having an elongated body extending between first and second ends, where the body further includes a rope mounting side and a device mounting side. The rope mounting side has an open cavity extending between the first and second ends and is dimensioned to receive at least a portion of a rope. The device mounting side has a pair of opposed flanges projecting outwards from the body, where an opening between the flanges is dimensioned to receive at least a portion of an acceleration measuring device therein. The adapter further includes a first securing mechanism adapted to reversibly secure the portion of rope positioned within the cavity in contact with at least a portion of a surface of the cavity such that the rope is substantially inhibited from moving with respect to the adapter body. The adapter also includes a second securing mechanism adapted to reversibly secure the portion of the acceleration measuring device positioned within the opening in contact with at least a portion of a surface of the opening such that the measurement device is substantially inhibited from moving with respect to the adapter body. The system further includes the acceleration measuring device, where the measuring device includes an accelerometer configured to measure a frequency of acceleration of rope movement when at least a portion of the rope is secured within the cavity and the acceleration measuring device is received within the opening of the device mounting side.

Embodiments of the system may include one or more of the following, in any combination.

In an embodiment, the system further includes a computing device in communication with the acceleration measuring device, where the computing device is configured to calculate the rope tension based upon the frequency of acceleration measured by the accelerometer of the acceleration measuring device.

In an embodiment of the system, the computing device further includes a display for displaying the calculated rope tension.

In an embodiment, a method for measuring rope tension is provided. The method includes providing a tension measuring system which includes an adapter and an acceleration measuring device. The adapter includes an elongated body extending between first and second ends. The adapter body further includes a rope mounting side and a device mounting side. The rope mounting side has an open cavity extending between the first and second ends and is dimensioned to receive at least a portion of a rope. The device mounting side has a pair of opposed flanges projecting outwards from the body. An opening between the flanges is dimensioned to receive at least a portion of the acceleration measuring device therein. The acceleration measuring device includes an accelerometer configured to measure a frequency of acceleration. The method includes the step of securing the portion of rope positioned within the cavity in contact with at least a portion of a surface of the cavity such that the rope is substantially inhibited from moving with respect to the adapter body. The method further includes the step of securing the portion of the acceleration measuring device positioned within the opening in contact with at least a portion of a surface of the opening such that the acceleration measuring device is substantially inhibited from moving with respect to the adapter body. The method also includes the steps of exciting the rope to create a movement of the rope, and measuring, by the acceleration measuring device, the frequency of acceleration of the rope movement.

Embodiments of the method may include one or more of the following, in any combination.

In an embodiment, the method further includes receiving, by a computing device in communication with the acceleration measuring device, the measured frequency of acceleration and calculating the rope tension based upon the measured frequency of acceleration measured.

In an embodiment, the method further includes displaying, by a display in communication with the computing device, the calculated rope tension.

In an embodiment, an adapter is provided. The adapter includes an elongated body extending between first and second ends. The body has a device mounting side and an elevator component mounting side. The device mounting side has a pair of opposed flanges projecting outwards from the body. An opening between the flanges is dimensioned to receive at least a portion of a measurement device. The device mounting side also has a securing mechanism adapted to reversibly secure a portion of an acceleration measuring device positioned within the opening in contact with at least a portion of a surface of the opening such that the acceleration measuring device is substantially inhibited from moving with respect to the adapter body. The elevator component mounting side comprises a first leg component and a second leg component. The first leg component is connected to and extends outwards from the elevator component mounting side at the first end. The first leg component comprises a first leg and a second leg. The second leg component is connected to and extends outwards from the elevator component mounting side at the second end. The second leg component has a third leg. The elevator component mounting side includes a second securing mechanism having an open cavity extending between the first and second ends of the elongated body and dimensioned to receive at least a portion of a rope such that the portion of the rope is in contact with at least a portion of a surface of the cavity and the rope is substantially inhibited from moving with respect to the elongated body.

Embodiments of the adapter may include one or more of the following, in any combination.

In an embodiment of the adapter, the elevator component mounting side is positioned opposite the device mounting side.

In an embodiment of the adapter, the first leg component and the second leg component are each removable.

In an embodiment of the adapter, the first leg component and the second leg component are each connectable to the elongated body in more than one orientation.

In an embodiment of the adapter, the elongated body includes at least one magnet.

In an embodiment, a system for measuring acceleration of an elevator component comprises an adapter and a measuring device. The measuring device comprises an accelerometer configured to measure a frequency of acceleration of rope movement when at least a portion of a rope is secured within a cavity of the adapter and the measuring device is received within an opening thereof.

According to yet another embodiment, a system for measuring acceleration of an elevator component comprises an adapter and a measuring device. The measuring device comprises an accelerometer configured to measure a frequency of acceleration of an elevator component when each of a first, a second, and a third leg of the adapter is in contact with a relatively horizontal surface of the elevator component and the measuring device is received within an opening of the adapter.

### BRIEF DESCRIPTION OF THE DRAWINGS

The foregoing and other objects, features and advantages will be apparent from the following more particular description of the examples, as illustrated in the accompanying drawings in which like reference characters refer to the same parts throughout the different views. The drawings are not necessarily to scale, emphasis instead being placed upon illustrating the principles of the examples.

FIGS. 1A-1B are schematic illustrations of embodiments of a system for measuring accelerations in an elevator system (e.g., accelerations of a suspension rope or accelerations of an elevator surface).

FIGS. 2A and 2B are block diagrams of embodiments of a measuring device, a user device, and a smart device.

FIGS. 3A-3F are multiple views of an embodiment of an adapter for attaching to a rope.

FIGS. 4A-4E are multiple views of another embodiment of the adapter for attaching to either a rope or a carpeted surface.

FIG. 5 is a flowchart of an embodiment of the application for analyzing rope tension.

FIGS. 6A-6I are user interfaces illustrating an embodiment of a method for analyzing rope tension.

FIG. 7 is a flowchart of an embodiment of a method for analyzing suspended load.

FIGS. 8A-8K are user interfaces illustrating an embodiment of a method for analyzing suspended load.

FIGS. 9A-9D are embodiments of user interfaces illustrating determination of at least one vibration metric for a suspended structure, such as an elevator.

### DETAILED DESCRIPTION

To determine the tension of a hoisting (suspended) rope and/or to determine the weight of an elevator cabin, a system is provided that includes an acceleration measuring device that attaches to the rope and measures acceleration data. This acceleration data can be used to determine a value indicative of rope tension and/or to determine the weight of an elevator cabin. For an accurate measurement, the system further includes an adapter that keeps the acceleration measuring device from moving relative to the rope. In some embodiments of the system, the measuring device can be attached to or placed onto various surfaces of the elevator system, such as an elevator cabin floor or an elevator traction machine, via the adapter, to measure acceleration data. This acceleration data can be used to determine a vibration intensity experienced by the elevator surface. Embodiments of the adapter allow the measuring device to be attached to or placed on a variety of surfaces including a ferrous surface, a non-ferrous surface, and a carpeted surface.

In one embodiment, the measuring device is reversibly secured to the adapter using one or more retention flanges. To attach the adapter to the rope, the adapter includes a first side having an open cavity configured to receive at least a portion of the rope (e.g., a concave opening or a v-shaped groove). For ropes made of a ferrous material, one or more magnets may be placed on or adjacent a surface of the cavity surface for magnetically securing the rope to the adapter. For non-magnetic (non-ferrous) ropes, the adapter may include slots for receiving cable ties and mechanically securing the rope to the adapter.

To place the adapter on a relatively horizontal surface, one embodiment of the adapter has two leg components that contain in total three legs. All three leg members of the adapter engage the relatively horizontal surface. In some embodiments, each of the three legs includes a retractable spike. These spikes may be employed to secure the adapter in place upon a carpeted surface of an elevator cabin floor, providing a solid stand for the measuring device. When the spikes are not needed, they can be retracted and hidden within the profiles of the two leg components. In an alternative embodiment, the spikes may be completely removed from the two leg members. When the legs of the leg components are not needed, the leg components can be removed from the adapter or placed in a storage position on the adapter. In some embodiments, the adapter also includes a magnet, placed at its end (e.g. a lower end) to attach the measuring device to a magnetic surface, such as an elevator traction machine.

The system may further communicate with a computing device executing software capable of calculating, based on the measured acceleration, one or more of: a value indicative of rope tension, the weight of the elevator cabin, and a vibration metric of an elevator surface. In some embodiments of the system, the software is executed on the measuring device. In further embodiments, the software is executed on a user device. In other embodiments, the software is executed on a smart device, such as a smart phone, and the system makes use of the inherent sensor(s) of the smart device to measure acceleration data.

In one embodiment, the software employs the acceleration of the rope movement or “acceleration data” acquired by the acceleration measuring device to determine the frequency of the acceleration change. For example, this frequency is equal to the fundamental harmonic of the rope, which may be related to the rope tension, as discussed in greater detail below.

Another embodiment of the software allows a technician to calculate the weight of the elevator cabin. The software employs the acceleration of the rope movement or “acceleration data” of the elevator system and determines the frequency of the acceleration change for each rope. The frequency is equal to the fundamental harmonic of the rope and is indicative of a tension value for the rope. Using the value indicative of rope tension, a length of the rope, and a linear mass density of the rope, the true tension of the elevator rope may be determined. This process is repeated for each portion of rope in the elevator system that is suspending an elevator car. The software determines the true tension reading for each elevator rope and sums them up to provide a tensional load of the cabin. The tensional load is equal to the weight of the elevator cabin.

Another embodiment of the software allows a technician to calculate the vibration intensity acting upon an elevator component. By interpreting acceleration readings in three dimensions (e.g., the x, y, and z directions) from the data measuring device, the application can express to the technician a vibration metric.

Yet another embodiment of the software sends and receives data of the frequency analysis, wirelessly, via a mobile (cellular) carrier or other wireless protocol, to be stored for further analysis. In some embodiments of the software, the number of ropes being analyzed may be varied. Furthermore, the manner in which the rope tension, true tension, and vibration intensity is calculated from the measured acceleration data may be modified, as necessary. In some embodiments, elevator job or elevator system specific data can be retrieved by the application via a mobile (cellular) carrier or other wireless protocol.

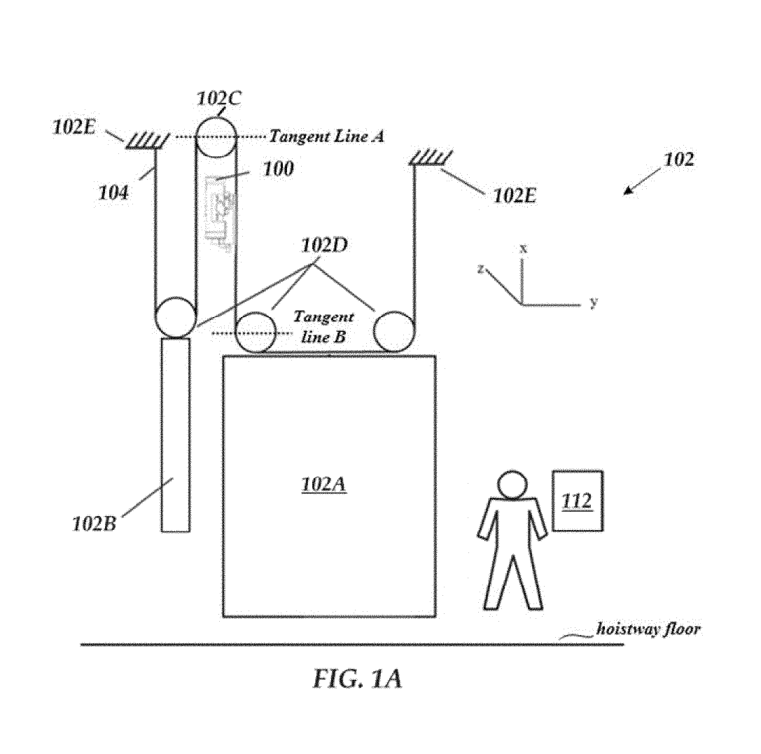

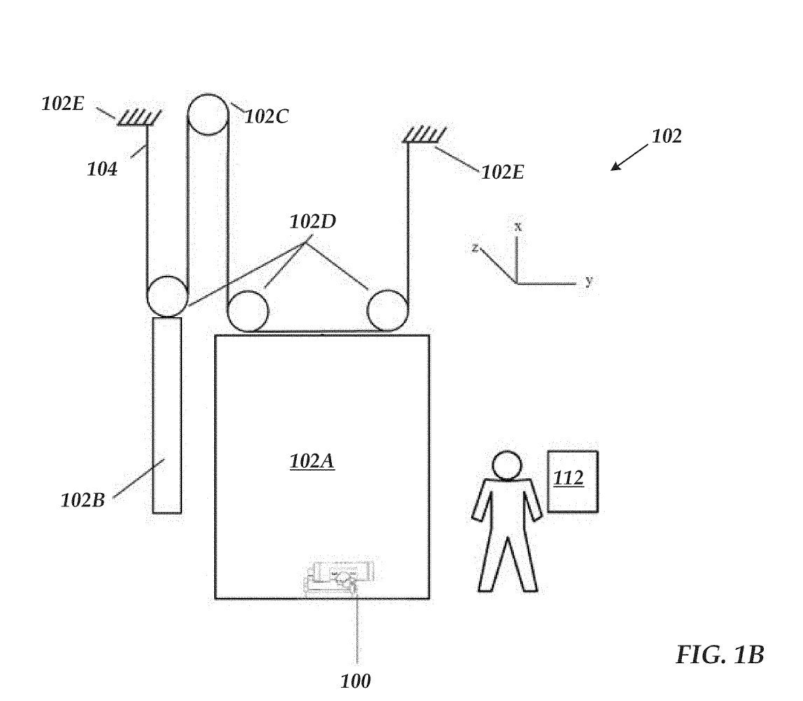

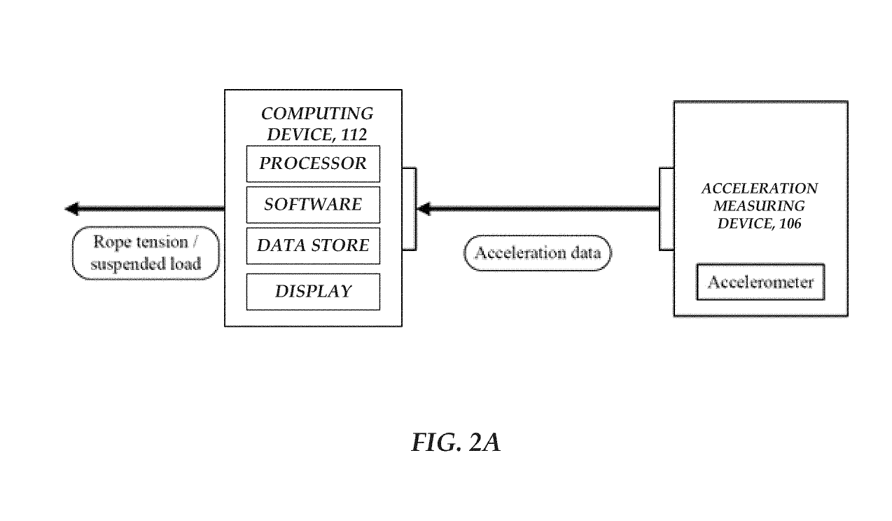

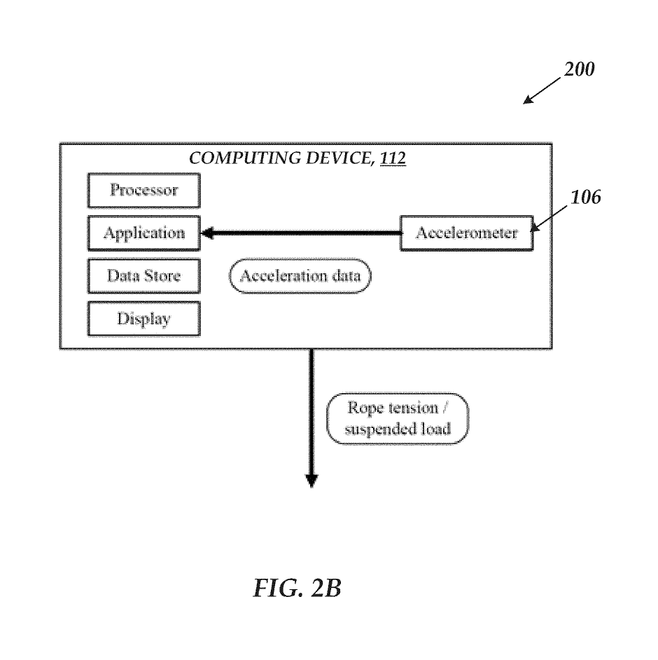

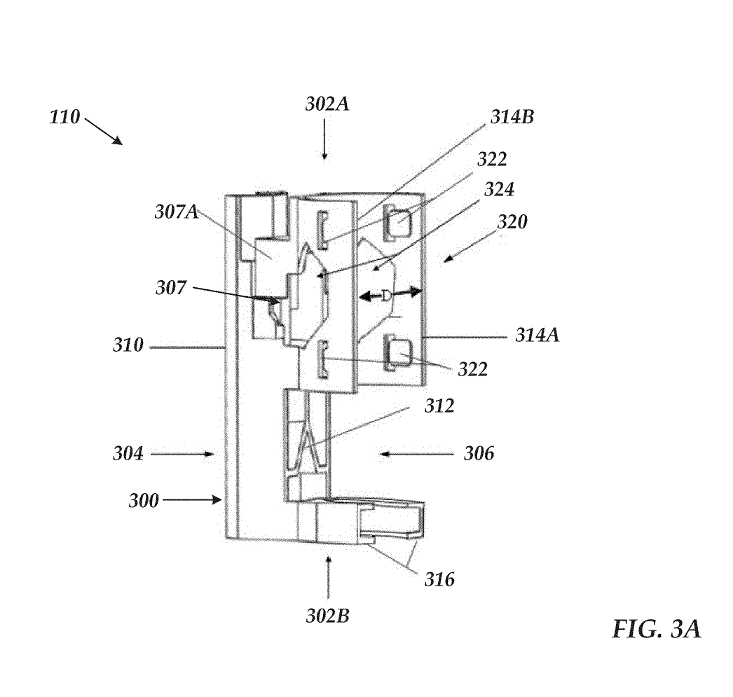

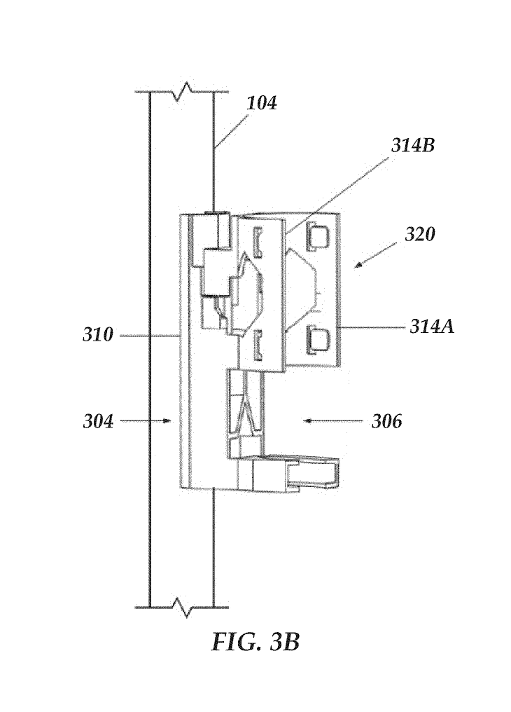

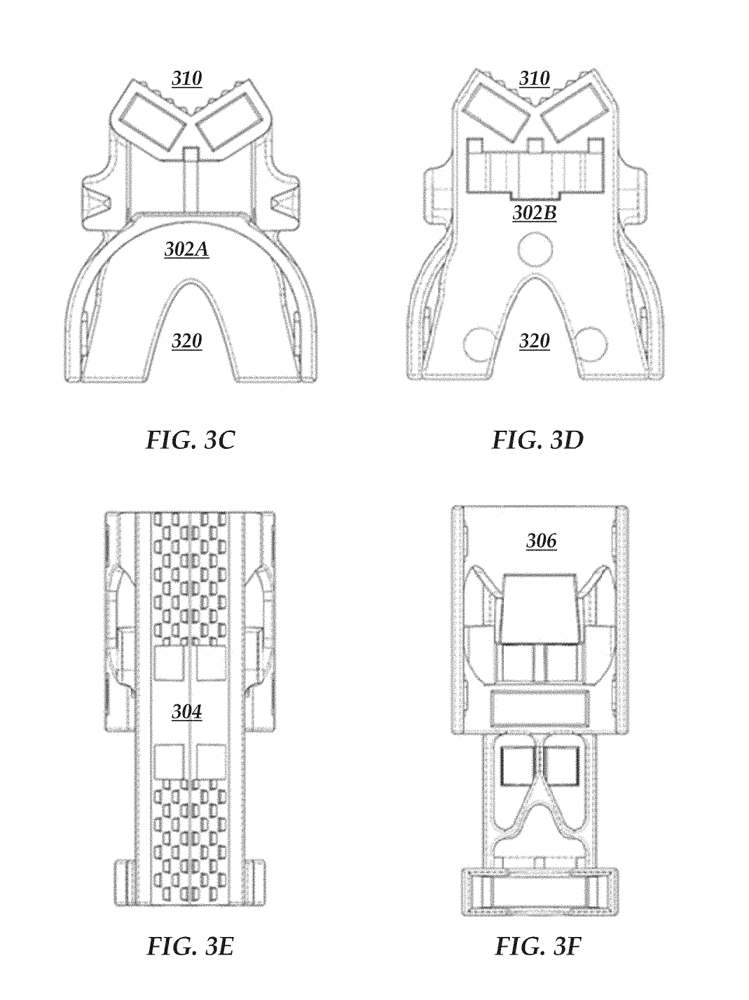

The discussion will now turn to FIGS. 1A-1B, illustrating system 100 for measuring accelerations in an elevator system 102. In the example shown, the elevator system 102 includes an elevator cabin 102A, counterweight 102B, traction motor/sheave 102C, deflecting sheaves 102D, and termination/shackle/dead-end-hitch 102E. Elevator ropes 104, of which one is shown, are routed through the deflecting sheaves 102C, 102D and suspend the elevator cabin 102A. The system 100, illustrated in greater detail in FIGS. 3A-3F, includes an acceleration measuring device 106 (see FIG. 2A) for measuring an acceleration of rope movement of the elevator rope 104, and an adapter 110 for attaching the measuring device to the elevator rope 104. In further embodiments, the system 100 optionally includes a computing device 112 for determining the value indicative of rope tension of the elevator rope 104 or weight of the elevator cabin 102A (also referred to as the suspended load). As will be discussed later, in other embodiments of the system 100, the acceleration measuring device 106 and the computing device 112 are combined into a single device.

As discussed in greater detail below, in certain embodiments (e.g., FIG. 1A), the system 100, including the acceleration measuring device 106 and the adapter 110, may be secured to the elevator rope 104 for measuring accelerations. In alternative embodiments, the acceleration measuring device 106 may be mounted to the floor of the elevator cabin 102A using the adapter 110.

FIG. 2A shows an embodiment of the acceleration measuring device 106 communicatively coupled to an embodiment of the computing device 112. The acceleration measuring device 106 includes an accelerometer for measuring the acceleration of the rope movement (e.g., movement of the elevator rope in the x, y, or z direction). Examples of the accelerometer include, but are not limited to, semiconductor accelerometers and piezoelectric accelerometers. One of ordinary skill in the art will recognize that embodiments of the system 100 are not limited to a particular type of accelerometer, however. The acceleration measuring device 106 further includes an interface for transmitting acceleration data measured by the accelerometer. Examples of the interface include a “wired” interface supporting wired communications, such as RS-232 and a “wireless” interface supporting wireless communications, such as Wi-Fi, Bluetooth, and cellular data. One of ordinary skill in the art will further recognize that embodiments of the system 100 are not limited to a particular type of interface.

In an embodiment, a Fast Fourier Transform (FFT) analysis is performed on acceleration data separately for x direction data, y direction data, and z direction data. Output from the FFT is several guesses for frequency. For the x direction, these guesses are generally close to zero, and as such, they may be ignored. All guesses from the y & z direction are combined and the median may be taken as the measured frequency for the rope.

Some embodiments of the acceleration measuring device 106 include a memory for storing acceleration data measured during a test. The stored acceleration data can then be accessed at a later time for analyzing the value indicative of tension of the elevator rope 104, analyzing the suspended load, or for other analysis. Such embodiments may be particularly useful for creating maintenance logs, for example.

An embodiment of the computing device 112 includes a corresponding interface for receiving the acceleration data measured by the acceleration measuring device 106. In a convenient embodiment, the acceleration measuring device 106 and the computing device 112 communicate with each other via a wired or wireless communications network (e.g., using Bluetooth™). The user device further includes a processor running an application for determining the value indicative tension and/or suspended load and/or vibration metric based on the acceleration data.

From the acceleration data, the computing device 112 determines the frequency of the acceleration change. The acceleration changes with respect to time from a positive local extreme to a negative local extreme. The number of times the acceleration value changes from positive to negative in a second is the actual measured frequency (in Hz).

This frequency is equal to the fundamental (natural) harmonic of the elevator rope. The harmonic frequency is related to rope tension and the computing device 112 executes software that uses this relationship to determine the value indicative of rope tension. In an embodiment, the relationship between the harmonic frequency of the elevator rope and true tension of the elevator rope is determined by Mersenne's laws (see equation 1).

T=4f²L²ρ (Eq. 1)

where T is the rope tension, L is the rope length, f is the fundamental frequency of the rope when vibrating, and ρ is the linear mass density of the vibrating rope. Alternatively, or in addition, a value indicative of rope tension (i.e., f² or f²L) may be determined.

In some embodiments, the tensional load of the elevator cabin 102A is determined from the tension of the elevator rope 104. The tensional load of the elevator cabin 102A is equal to the weight of the elevator cabin 102A. In cases in which the elevator cabin 102A is suspended by multiple elevator ropes 104, a technician (user) takes an acceleration measurement of each of the elevator ropes 104 and the computing device 112 determines the tensional load of the elevator cabin 102A from these measurements.

A result of the analysis (value indicative of rope tension, suspended loaded, or vibration metric) or an indication thereof is provided to the technician through a display. In certain embodiments, the display may be integrated with the computing device 112 (e.g., in circumstances where the computing device is a portable computing device such as a laptop, tablet, smartphone, etc.). In alternative embodiments, the analysis may be displayed on a separate display device. In some examples, the result is stored, internally, in a data store (memory).

The data store can also store parameters used to determine “true” tension and/or suspended load based on the acceleration data, such as the linear density and length of a rope under test. The parameters are inputted into the computing device 112 using a user interface, such as a keyboard (not shown) or the display, which is touch-sensitive. In other examples, the results may be communicated to an external entity, such as a service center.

Another embodiment of the acceleration measuring device 106 further includes a distance measurement tool for measuring the length of the elevator rope 104. In an embodiment, the length (L) of the elevator rope 104 used to analyze the measured accelerations is not the entire length of the elevator rope 104 or, when multiple ropes are present, the sum of all rope lengths. Rather, as used herein, the “rope length” (L) is given by the distance between rope contact points for a portion of rope to which the adapter 110 is attached. A contact point may be: at a sheave, a shackle, a dead end hitch or a termination. For example, in the embodiment of FIG. 1A, the rope length is the distance between A) the rope contact point on the traction sheave defined by a tangent line between the traction sheave and the hoistway floor and B) the rope contact point on the left deflecting sheave mounted to the elevator car defined by a tangent line between the left deflecting sheave and the hoistway floor.

This embodiment is advantageous because it measures the rope length L of the elevator rope 104 and its natural frequency in a single step. Both length and natural frequency measurements can be used to calculate the “true” tension.

FIG. 2B shows an embodiment of an integrated computing device 200 combining the acceleration measuring device 106 and the computing device 112 device described above with reference to FIG. 2A. In example embodiments, the integrated computing device 200 includes a built-in accelerometer, and is configured to execute the analysis software. Examples of the integrated computing device 200 include handheld PCs, tablets, smart phones, and portable sensor boxes, just to name a few. One of ordinary skill in the art will readily recognize that examples of the system 100 are not limited to a particular type of smart device or form factor.

An embodiment of the system 100 including the integrated computing device 200 is particularly advantageous because it is a low-cost solution for measuring value(s) indicative of rope tension and/or suspended load and/or vibration metrics. For example, a typical smart phone with a built-in accelerometer can be made into the integrated computing device 200 by storing and executing the analysis software on the smart phone. This not only avoids the need to buy expensive equipment but also facilitates the adoption of the technology.

FIGS. 3A-3F are schematic illustrations of an embodiment of the adapter 110. The adapter 110 possesses an elongated body 300 extending between a first end 302A and a second end 302B. The adapter body 300 further including a rope mounting side 304 for attaching the adapter 110 to the elevator rope 104, and a device mounting side 306 opposite the rope mounting side 302 for attaching the acceleration measuring device 106 to the adapter 110. The rope mounting side 304 includes an open cavity 310 for engaging the elevator rope 104. In certain embodiments, the open cavity 310 adopts a V-shape with opposing faces extending from the rope mounting side 304 toward the device mounting side 306 at an acute angle with respect to the rope mounting side 304. The opposing faces meet at a location between the rope mounting side 304 and the device mounting side 306. This embodiment of the adapter 110 is particularly advantageous because it accommodates a variety of rope diameters. In another embodiment of the adapter 110, the open cavity 310 surface is concave in shape (e.g., ovular, hemispherical, etc.). The surface of the open cavity 310 extends, in an arcuate path, from the rope mounting side 304 towards the device mounting side 306 and back to the rope mounting side 304. In this embodiment, the radius of the open cavity 310 is at least the radius of the elevator rope 104.

The rope mounting side 304 may further include one or more magnets (not shown) for magnetically attaching the adapter 110 to an elevator rope 104 made from a ferrous material. In an adapter 110 embodiment having the V-shaped open cavity 310, a magnet may be disposed on or adjacent each face of the open cavity surface, and one magnet may be disposed at a platform portion 312. One of ordinary skill in the art will readily recognize that fewer (or additional) magnets may be used and other configurations are possible (e.g., each face may be covered with a magnetic sheet).

Another embodiment of the adapter 110 includes at least one pair of slots 307, each defined near opposite ends of the open cavity 310 (e.g., proximate body portion 307A). In further embodiments, more than one pair of slots 307 may be present. The technician may thread a cable tie through the slots 307 to secure the adapter 110 to a non-ferrous elevator rope 104.

Yet another embodiment of the adapter 110 may include both magnets and slots for securing the adapter 110 to an elevator rope 104. This embodiment is particularly advantageous because the adapter 110 can used on both ferrous and non-ferrous elevator ropes.

An embodiment of the device mounting side 306 includes a platform portion 312, retention flanges 314A, 314B (collectively retainer 314) and a stop 316 extending from the platform portion 312 for reversibly securing the acceleration measuring device 106 to the adapter 110. In the example shown, the retainer 314 includes a pair of retention flanges 314A, 314B extending from the platform portion 312. The retention flanges 314A, 314B are opposed and separated from each other by a distance (indicated in FIG. 3A by “D”) to define an opening 320 for receiving the acceleration measuring device 106. The shape of the opening 320 may complement the shape of the acceleration measuring device 106. For example to receive a cylindrical-shaped measuring device, the retention flanges 314A, 314B may be formed so as to curve, inwardly, toward each other and define a generally cylindrical-shaped opening.

In some embodiments, the distance (D) between the retention flanges 314A, 314B is smaller than a dimension of the acceleration measuring device 106 that is being held. The retention flanges 314A, 314B are further designed to flex (bend) when holding the acceleration measuring device 106 (e.g., the retention flanges 314A, 314B are made from a resilient material, or include hinges formed at the base of the retention flanges where they meet the platform portion 312). In such a configuration, the retention flanges 314A, 314B provide a bias force that advantageously enhances the grip that the retainer 314 has on the acceleration measuring device 106.

In another embodiment (not shown), one or more straps may extend between the retention flanges for further securing the acceleration measuring 106 device to the adapter 110. In yet another embodiment, a combination of the aforementioned retainers may be used.

In further embodiments, a plurality of retention clips 322 may be formed within the retention flanges 314A, 314B. The retention clips 322 may mechanically engage the acceleration measuring device 106 for attachment to the adapter 110.

When attached to the adapter 110, the acceleration measuring device 106 may be oriented with interface and/or input components of the acceleration measuring device, such as a USB port and power button, facing away from the adapter 110. This orientation is beneficial because these parts of the acceleration measuring device 106 are fully visible and readily accessible to the technician.

FIG. 3B shows the adapter 110 (without the acceleration measuring device 106 attached, for clarity) mounted to the elevator rope 104. To use one embodiment of the adapter 110, the technician clips (attaches) the acceleration measuring device 106 into engagement with the retention flanges 314A, 314B (e.g., using retention clips 322) and the platform portion 312 of the adapter 110. The technician then attaches the adapter 110 to a ferrous (magnetic) elevator rope 104 by aligning the open cavity 310 (e.g., a V-shaped profiled surface) with the elevator rope 104. The magnets of the rope mounting side 304 magnetically secure the adapter 110 to the elevator rope 104. If the elevator rope 104 is non-ferrous (non-magnetic), the technician pulls a cable tie(s) through the slots of the rope mounting side 304, around the elevator rope 104, and locks the cable tie to secure the adapter 110 to the elevator rope 104. The technician is now ready to conduct a test to determine the value indicative of tension of the elevator rope 104 or to determine a load suspended by the elevator rope, or to determine a vibration metric as described in greater detail below.

The technician detaches the adapter 110 from the elevator rope 104 by either simply removing the adapter 110 from the elevator rope 104 or by unfastening or cutting the cable tie securing the adapter 110 to the elevator rope 104. The technician then releases the acceleration measuring device 106 from the adapter 110 by pushing the acceleration measuring device 106 out of engagement with the retention flanges 314A, 314B and the platform portion 312 of the adapter 110. In the embodiment shown in FIG. 3A, the retention flanges 314A, 314B include apertures 324 to facilitate removal of the acceleration measuring device 106 from the adapter 110.

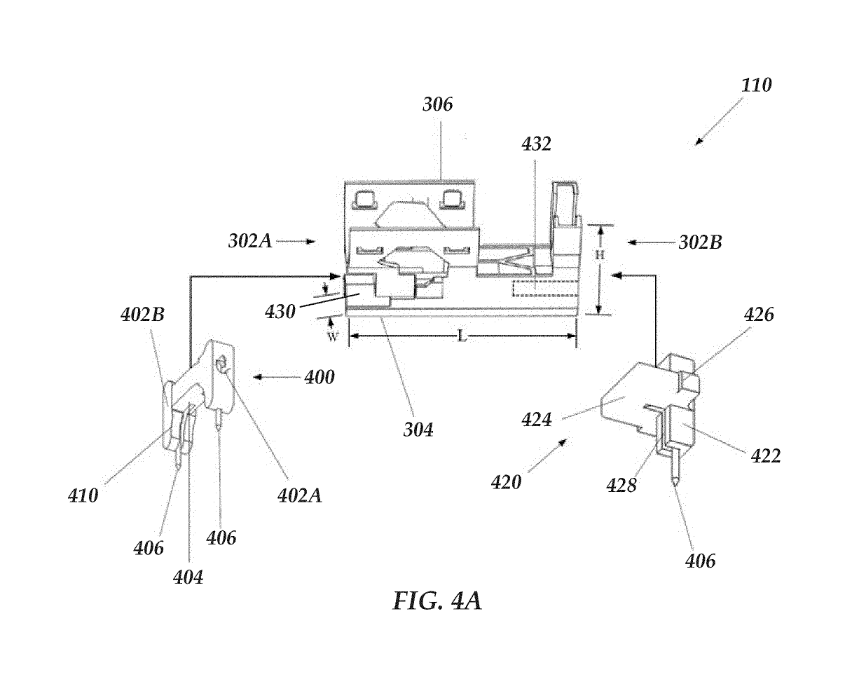

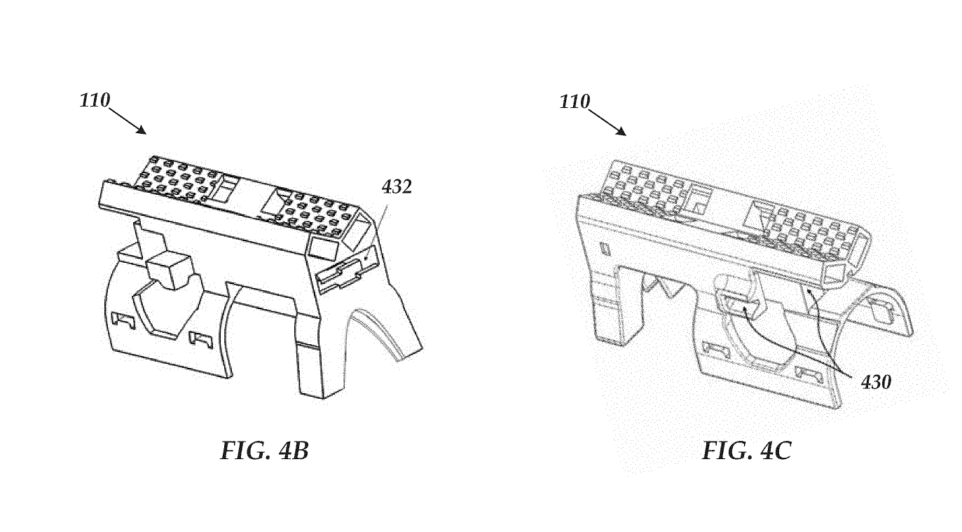

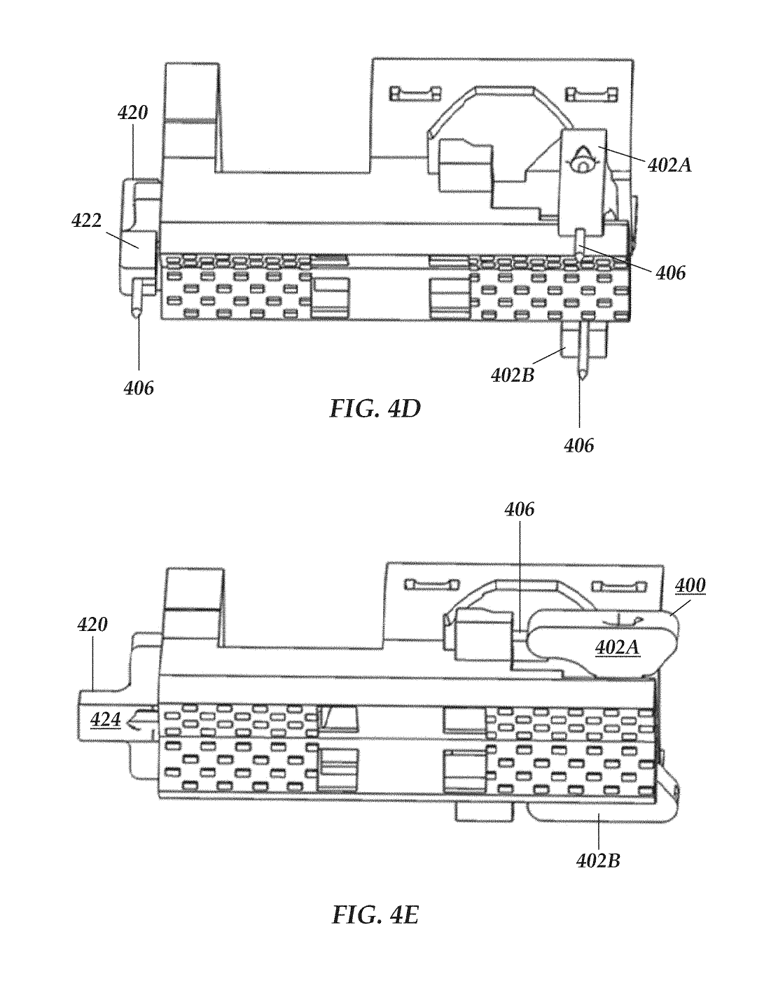

FIGS. 4A-4E shows another embodiment of the adapter 110 configured for engagement with a surface (e.g., a floor) of the elevator cabin 102A. The adapter 110 includes the elongated body 300, a first leg component 400 and a second leg component 420. Much of the description provided above with reference to FIGS. 3A-3F applies to this embodiment of the adapter 110, and is not repeated.

The first leg component 400 includes opposing leg members 402A, 402B spaced apart from one another and interconnected by a cross-member 404. In the embodiment shown, the leg members 402A, 402B are approximately orthogonal to the cross-member 404. The second leg component 420 includes a leg member 422 and a plug 424 oriented approximately orthogonal to one another.

An end surface of each leg member 402A, 402B, 422 is designed to engage the surface of the elevator system (e.g., the elevator cabin 102A) and transmit vibrational energy from the surface to the acceleration measuring device 106. In an embodiment, each of the three leg members 402A, 402B, 422 have attached thereto a retractable spike 406. These spikes 406 can penetrate the tuft of a carpeted surface of an elevator cabin 102A, providing a solid stand for the acceleration measuring device 106. When the spikes 406 are not needed, they can be retracted and hidden within the profiles of the leg components 400, 420.

In an alternative embodiment (not shown), the spikes 406 may be completely removed from the two leg members. When the leg members of the leg components are not needed, the leg components can be removed from the adapter or placed in a storage position on the adapter. The spikes 406 may be made of metal, polymers, or other desirable materials.

The elongated body 300 has a length, a width, and a height, which are indicated in the figure as “L,” “W,” and “H,” respectively. At the first end 302A of the adapter 110, a first leg slot 430 extends along the width of the elongated body 300 for receiving the first leg component 400. Formed at the second end 302B of the adapter, a receptacle 432 extends part way along the length of the elongated body 300 towards the first end 302A of the adapter 110 for receiving the second leg component 420. In an embodiment, the first leg slot 430 and receptacle 432 are sized to frictionally engage the cross-member 404 and the plug 424, respectively. When assembling the adapter 110, some force is needed to fit the cross-member 404 of the first leg component 400 into the first leg slot 430 and to fit the plug 424 of the second leg component 420 into the receptacle 432. In other words, there is an interference or friction fit between the cross-member 404 and the first leg slot 430, and the plug 424 and the receptacle 432.

FIG. 4D shows the adapter 110 assembled with the members of the first leg component and second leg component aligned with the direction of the height (H) of the adapter. In the example shown, the members of the first leg component are to either side (or outboard) of the elongated body and the member of the second leg component is aligned with the centerline of the elongated body. This arrangement is particularly useful because it provides a stable platform for mounting the measuring device/smart device and improves acceleration measurement sensitivity.

In a convenient embodiment, the first and second removable leg components 400, 420 can each be installed in two different orientations: (1) a usable position in which the spikes 406 extend from the first and second removable leg components 400, 420 in a direction approximately perpendicular to a line extending along the vertex of the V-shaped profiled surface and terminate in a plane beyond a termination plane of the V-shaped profiled surface (FIG. 4D); and (2) a storage position in which the spikes 406 are hidden within appropriate receiving portion so that the spikes 406 are aligned approximately parallel with a line extending along the vertex of the V-shaped profiled surface (FIG. 4E).

The embodiment shown in FIGS. 4A-4E further includes other structural features for making it easier for the technician to assemble the adapter 110. For example, the first leg slot 430 and the first leg component 400 have corresponding inclined surfaces 410 that help align the first leg slot 430 and the first leg component 400 during assembly. The second leg component 420 includes haunches 426 and surfaces 428 that limit how far the plug 424 can be inserted into the receptacle 432.

In an embodiment, the adapter 110 can be disassembled by removing the first leg component 400 from the first leg slot 430 and the second leg component 420 from the receptacle 432, as illustrated in FIG. 4E. This embodiment is particularly advantageous because the adapter 110 can be used in the assembled form when mounting the adapter 110 to a surface. When mounting the adapter 110 to an elevator rope 104, the leg components 400, 420 are not installed. Instead the open cavity 310 is used for mounting, as described above. In alternate embodiments, the leg components 400, 420 may be installed in the storage position when the adapter 110 is mounted to the elevator rope 104.

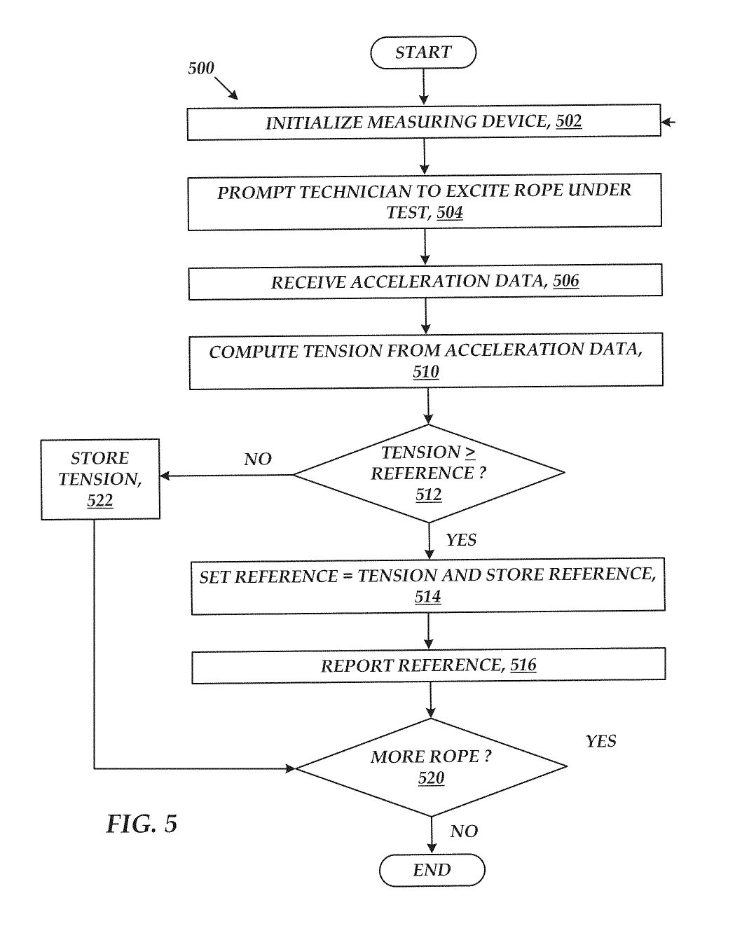

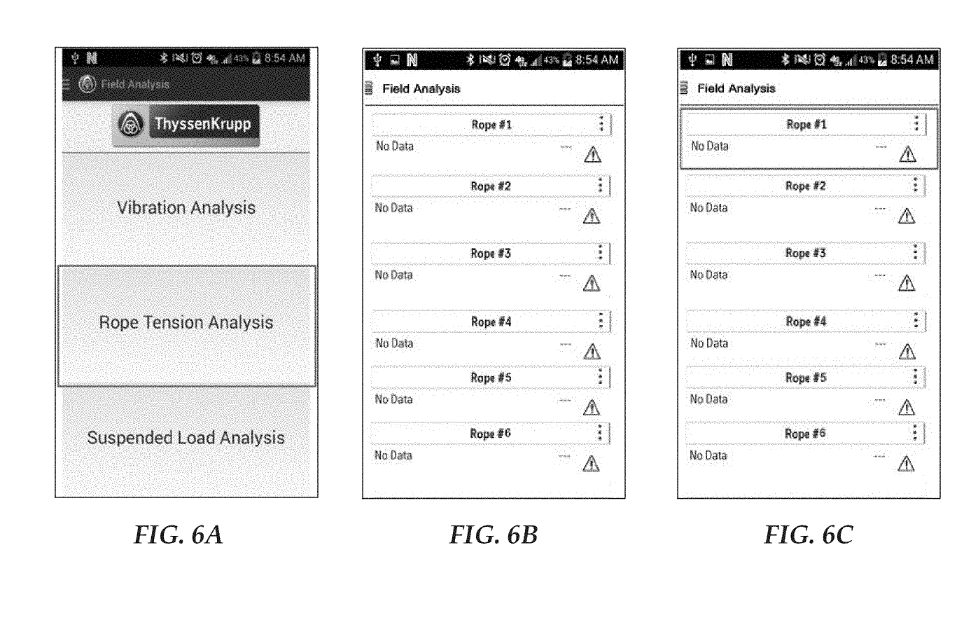

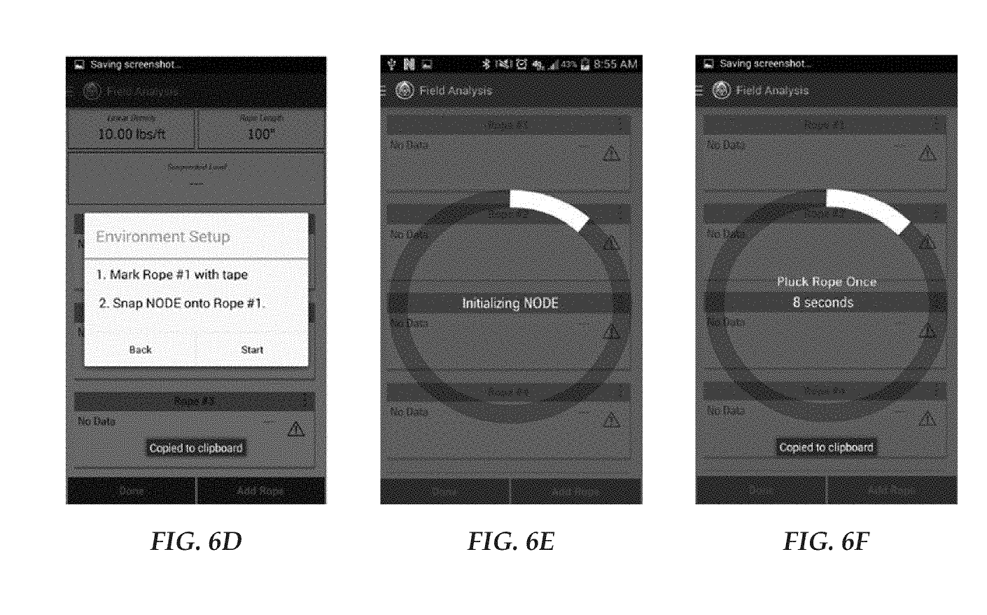

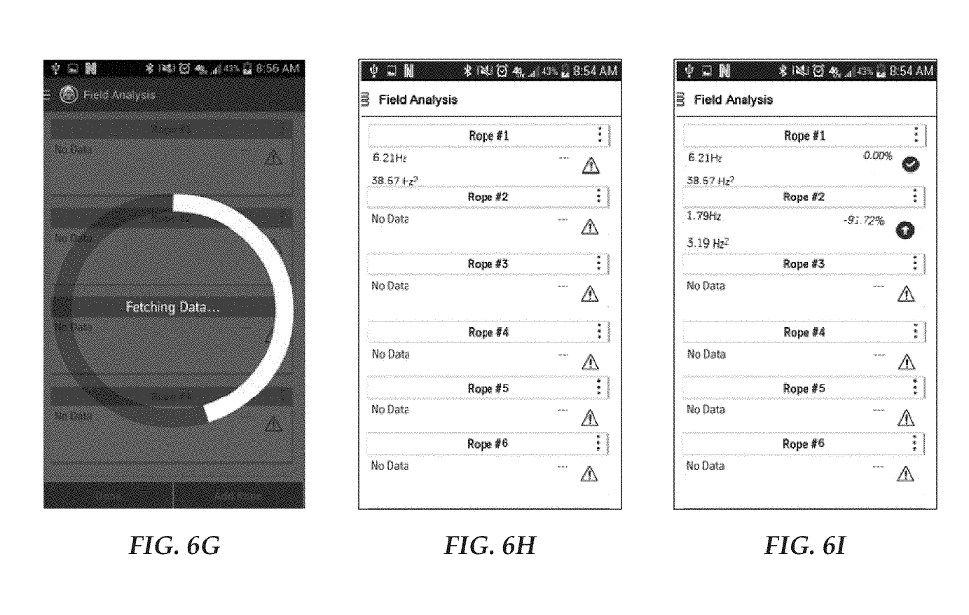

FIG. 5 is a flow diagram illustrating an embodiment of a method 500, including operations 502-522, that may be performed by the executed software when determining a value indicative of rope tension. Hereinafter, “the value indicative of rope tension” will be referred to simply as “tension”. This and other embodiments are described in the context of a sample field analysis including a first rope under test and a second rope under test. The tension of the first rope under test may be higher than, lower than, or approximately equal to the tension of the second rope under test. Additionally, embodiments of the software executed by the computing device 112 are described with reference to FIGS. 6A-6I, which illustrate user interfaces generated and displayed during the sample field analysis, as seen by the technician who is viewing a display in communication with the computing device 112.

When the technician executes the software on the computing device 112, the user interface of FIG. 6A is displayed and provides the technician with a suite of analysis that the technician can choose to carry out. In response to the technician selecting “Rope Tension Analysis,” a number of ropes for testing during the sample field analysis are provided. In the example embodiment shown in FIG. 6B, up to six ropes for testing may be selected. In some embodiments, the number of ropes for testing is set by default. In another embodiment the technician sets the number of ropes for testing by adding or subtracting a rope for testing. For example, by selecting the three vertically aligned dots on the right of the heading for each rope, a new dialog box may be opened that provides the option to rename or delete the corresponding rope. This embodiment is beneficial because the software can accommodate a variety of elevator configurations.

When the technician selects the first rope under test for analysis (see FIG. 6C), the technician is provided with instructions for setting up the analysis. For example, as illustrated in the user interface of FIG. 6D, the technician is instructed to mark the first rope under test and to attach the adapter 110 with the acceleration measuring device 106 (referred to as “node”) to the first rope under test. Once done, the technician starts the test.

In operation 502, the acceleration measuring device 106 is initialized, preparing the acceleration measuring device 106 for measuring and collecting acceleration data. In the embodiment shown in FIG. 6E, an indication that the acceleration measuring device 106 is being initialized is further provided. Subsequently, in operation 504, the technician is prompted to excite the first rope under test to create a movement in the rope.

The acceleration measuring device 106 then measures the acceleration of the rope movement over a period of time. For example, the acceleration measuring device 106 may digitally “sample” the measured acceleration data and store the values. Each sample is a record of the acceleration at that point in time in 3 axes: (e.g., x, y, and z), along with a time stamp. In certain embodiments, the time stamp may be omitted (e.g., under circumstances where the sampling rate is known). These acceleration values are used to compute a frequency spectrum for each axis, and the algorithm uses data in each spectrum to determine the frequency of the rope. In alternative embodiments, other methods may be employed for determining the fundamental frequency using time-domain methods, such as time-domain autocorrelation.

In the embodiment shown in FIG. 6F, a countdown timer is provided to show how much time is left for collecting acceleration data. At the end of the time period, in operation 506, the acceleration data is received by the computing device 112 from the acceleration measuring device 106. In the embodiment shown in FIG. 6G, an indication of the status of the data transfer may also be provided.

In operation 510, the measured acceleration values are used to compute a frequency spectrum for each axis (e.g., using a Fast Fourier Transform) and data in each spectrum is used to determine the frequency of the rope. The tension of the first rope under test is further determined from the received acceleration data, as described previously with reference to FIGS. 2A and 2B. The tension of the first rope under test is stored as a reference and reported to the technician. In the embodiment shown in FIG. 6H, the tension is shown as a square of the frequency (e.g., 38.57 Hz²). In some embodiments, the frequency of the rope under test is also displayed for the technician. The technician then selects the second rope under test for analysis. Continuing with the sample field analysis, operations 504-510 are repeated to further collect and analyze acceleration data for the second rope under test. In the embodiment shown in FIG. 6I, the tension of the second rope under test is shown as a square of the frequency (e.g., 3.19 Hz²). In some embodiments, the frequency of the rope under test is also displayed for the technician.

In operation 512, the tension of the second rope under test is compared with a reference, previously set to the tension of the first rope under test, and a determination is made whether the tension of the second rope under test is less than, greater than, or equal to the reference.

If the tension of the second rope under test is greater than the reference, then the method 500 moves to operation 514, where it stores the tension of the second rope under test as the new reference. If the tension of the second rope under test is less than or equal to the reference, method 500 moves to operation 522. The software now calculates the percent difference between the tension of the first rope and the reference i.e. (reference-first rope tension)/reference and the percent difference between the tension of the second rope and the reference i.e. (reference-second rope tension)/reference.

If the tension of all ropes are approximately equal (e.g., the difference between the tension of the first and second ropes is less than a selected threshold), the application shows the percent difference between the tension of the first and second ropes to be 0% and no further action is needed, as the ropes are already within tolerance. In example embodiments, the tension of the ropes may be considered to be within an acceptable tolerance if the tension of the tautest rope is no more than 10% tauter than the tension in the slackest rope.

In either circumstance, stored tension of the second rope under test is also reported to the technician in either operation 516 or 522. In the embodiment shown in FIG. 6I, the application provides the tension second rope as a frequency and a square of the frequency. The percent difference between the tension of the first rope and the reference and the percent difference between the tension of the second rope and the reference may also be reported to the technician.

In the embodiment of FIG. 6I, the first rope has a higher tension than the second rope. Thus, the tension of the first rope is kept as the reference. The percent difference between the reference and the first rope tension is therefore 0%, and the percent difference between the reference and the second rope tension is a non-zero value.

In operation 520, a determination is made whether there is more rope to test. If so, the method 500 returns to operation 502. If not, the method 500 ends. Once all ropes for testing in the sample field analysis are tested, the technician may employ the testing results to determine what action to take to equalize the rope tension.

In an alternative embodiment, the tension of the second rope under test is defined as f²L², where L is the rope length under test. The rope length under test is defined as the distance between rope contact points for a portion of rope to which the adapter is attached. A contact point may be: at a sheave, a shackle, a dead end hitch or a termination. For example, In FIG. 1A, the rope length would be the distance between A) the contact point on the traction sheave defined by a tangent line between the traction sheave and the hoistway floor and B) the left deflecting sheave mounted to the elevator car. The technician may be prompted to enter the appropriate rope length for the rope under test, or the appropriate rope length may be automatically retrieved.

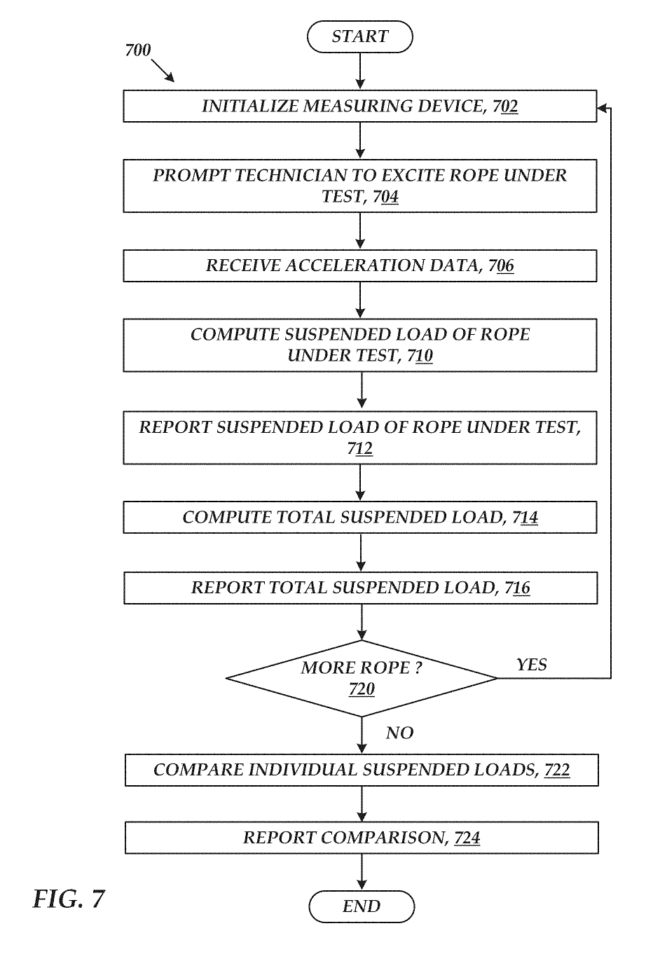

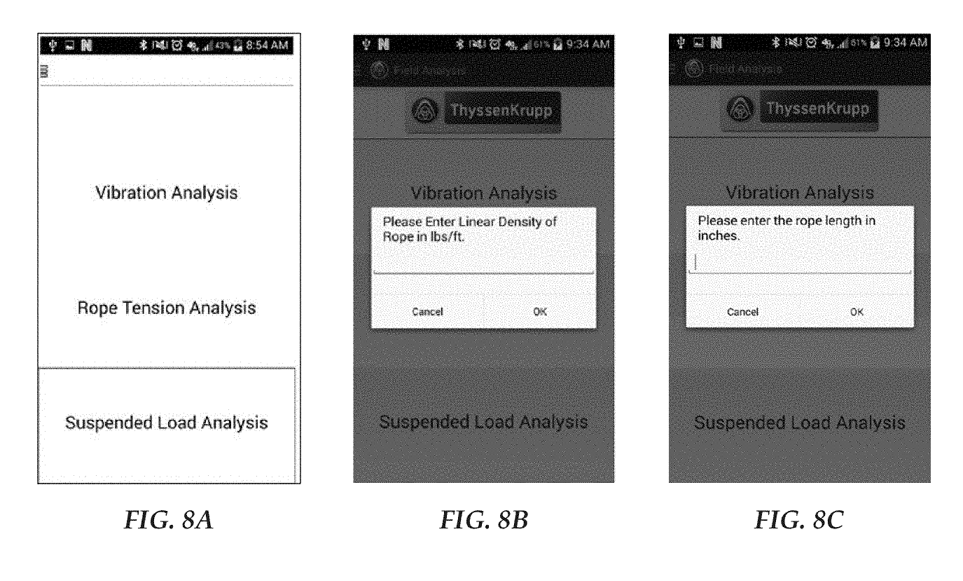

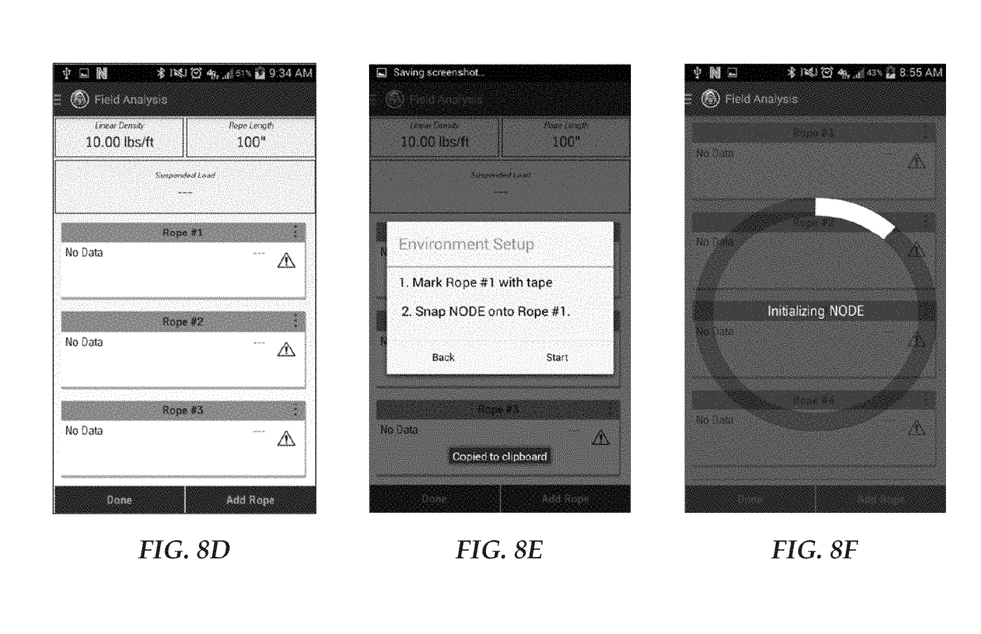

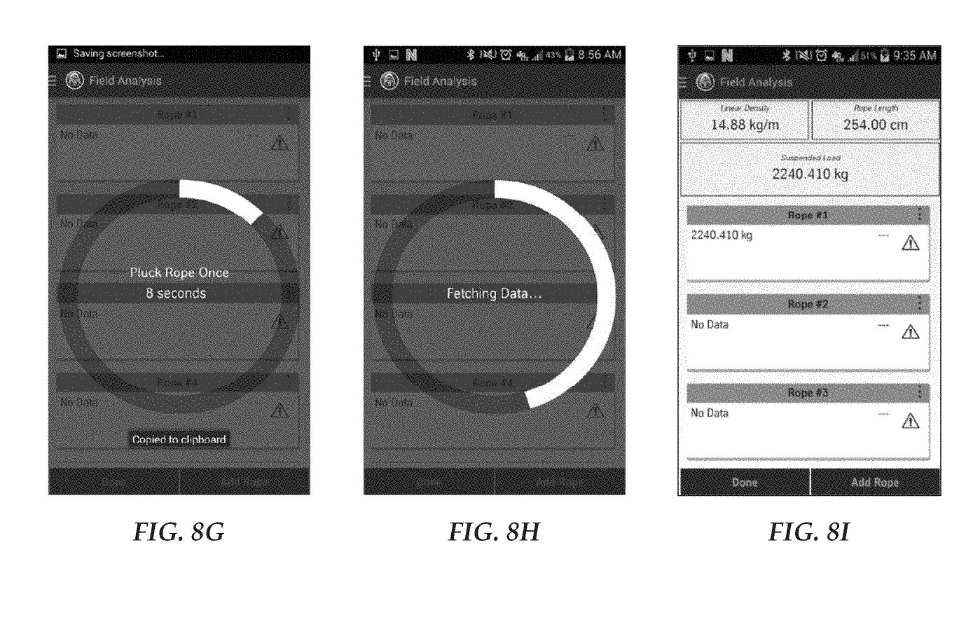

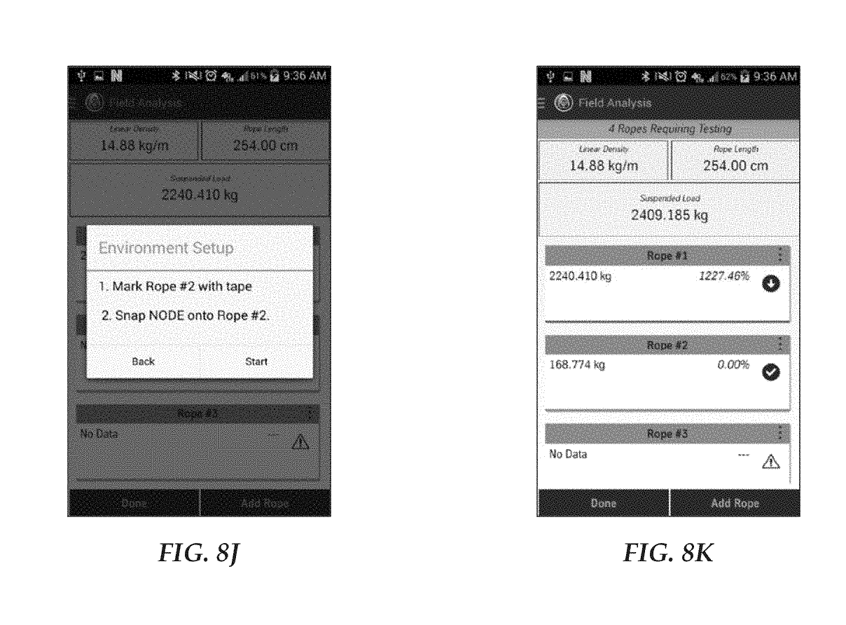

FIG. 7 shows an embodiment of for a method 700 determining suspended load. The discussion of the method 700 will be described in the context of a sample field analysis including a first rope under test and a second rope under test. In an embodiment, the tension of the first rope under test may be higher than the tension of the second rope under test. However, it may be further understood that, in alternative embodiments, the first rope may have a tension that is equal to or lower than the second rope. Additionally, FIGS. 8A-8K present user interfaces corresponding to the operations of the sample field analysis method 700 as seen by the technician who is viewing the display of the computing device 112.

When technician executes the software on the computing device 112, technician is provided with a suite of analysis that the technician can choose to carry out (FIG. 8A). In an elevator system 102 where all elevator ropes 104 have a substantially equivalent rope length, the technician is prompted to enter the linear density and the standard length of the rope being tested as shown in FIGS. 8B and 8C. In an elevator system 102 where elevator ropes 104 have varying lengths, the prompt for rope length may be omitted. In another embodiment, all rope linear density and rope length values for the specific elevator system under test are retrieved (e.g., from a data storage device in communication with the computing device 112), as illustrated in FIG. 8D.

The technician further selects the first rope under test for testing. If the technician did not previously enter a standard rope length for the first rope, or if the first rope length was not automatically retrieved, the technician may be prompted to enter the length of the rope under test. The technician is then prompted with instructions for setting up the test. In embodiment shown in FIG. 8E, the technician is instructed to mark the first rope under test and to attach the adapter 110 with the acceleration measuring device 106 to the first rope under test. Once done, the technician starts the test.

In operation 702, the acceleration measuring device 106 is initialized, which prepares the acceleration measuring device 106 for measuring and collecting acceleration data. In the embodiment shown in FIG. 8F, an indication is provided that the acceleration measuring device 106 is being initialized. In operation 704, the technician is instructed to excite the first rope under test to create a movement in the rope.

The measuring device measures the acceleration of the rope movement over a period of time. For example, the acceleration measuring device 106 may digitally “sample” the measured acceleration data and store the values. Each sample is a record of the acceleration at that point in time in 3 axes: (e.g., x, y, and z), along with a time stamp. In certain embodiments, the time stamp may be omitted (e.g., under circumstances where the sampling rate is known).

In the embodiment shown in FIG. 8G, a countdown timer showing how much time is left for collecting acceleration data is provided. At the end of the time period, in operation 706, the acceleration data is received by the computing device 112 from the acceleration measuring device 106. In the embodiment shown in FIG. 8H, the application provides an indication of the status of the data transfer.

In operation 710, the suspended load of the first rope under test from the acceleration data is computed, as described previously with reference to FIGS. 2A and 2B. In operation 712, the suspended load of the first rope under test is reported to the technician. In the embodiment shown in FIG. 8I, the suspended load of the first rope under test is shown as a mass (e.g., 2240.410 kg) representing the total mass being supported by the rope under testing. The suspended load of the first rope under test is further stored as a reference.

In operation 714, the total suspended load is determined by summing the suspended load of the first rope under test with the suspended loads of other rope under tests. The determined total suspended load is further reported to the technician in operation 716. In the embodiment shown in FIG. 8I, only the first rope under test has been tested thus far, so the total suspended load is equal to the suspended load of the first rope under test.

The technician now selects the second rope under test for testing. Subsequently, the method 700 returns to operation 702 and the second rope is subject to operations 702-720 in the same manner as described above with respect to the first rope under test. The application computes the suspended load of the second rope under test and reports it to the technician.

Once all ropes have been measured, the method 700 moves to operation 722, where the suspended load of the second rope under test is compared with the reference (which was previously set to the tension of the first rope under test) to determine whether the suspended load of the second rope under test is less than, greater than, or equal to the reference. If the suspended load of the second rope under test is greater than the reference, then the application sets and stores the suspended load of the second rope under test as the new reference. If the suspended load of the second rope under test is less than or equal to the reference, the application keeps the original reference. If the suspended load of all the ropes are approximately equal, no further action is needed, as the ropes are already within tolerance.

Subsequently, the percent difference between the suspended load of the first rope and the reference and the percent difference between the suspended load of the second rope and the reference is determined. In operation 724, the percent difference between the suspended load of the first rope and the reference and the percent difference between the suspended load of the second rope and the reference are reported to the technician.

The total suspended load is determined by summing the suspended load of the first rope under test and the suspended load of the second rope under test. The total suspended load is further reported to the technician. In the embodiment shown in FIG. 8K, the total suspended load and the suspended loads of the first and second rope under test are shown as masses 2409.185 kg. The above is repeated for each portion of rope in the elevator system that is suspending an elevator car.

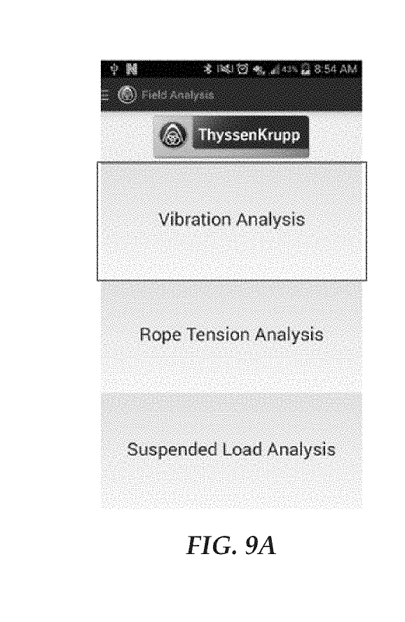

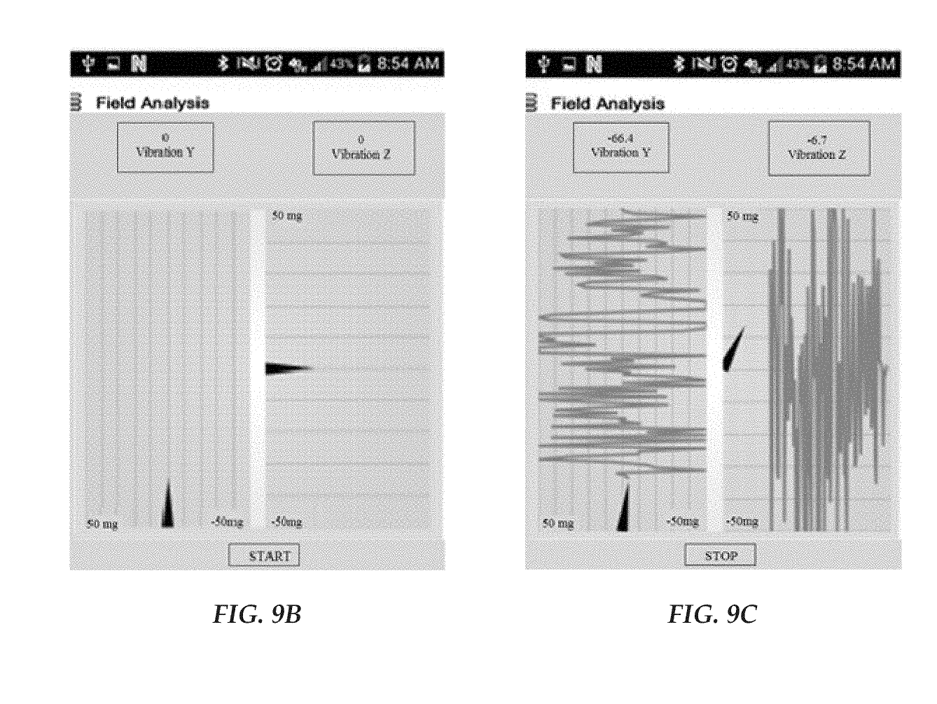

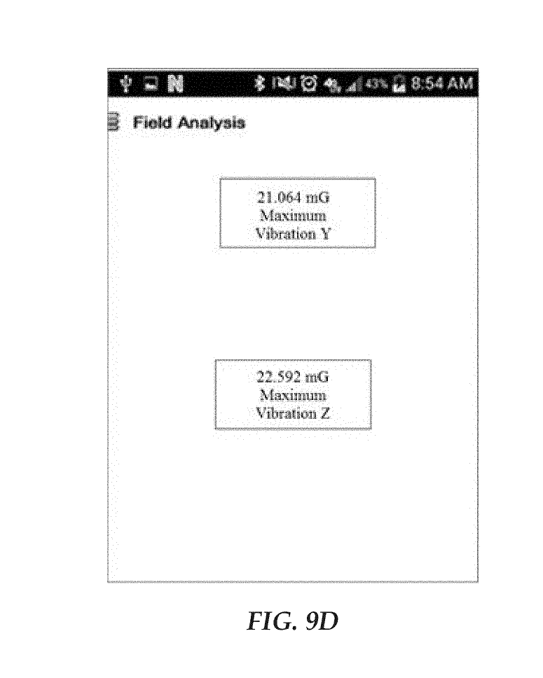

FIGS. 9A-9D show embodiments of user interfaces illustrating determination of at least one vibration metric. For example, the technician selects a “vibration analysis” option displayed by the computing device 112. In response, the maximum vibration measured by the acceleration measuring device 106 in the y and z direction may be displayed, as illustrated in FIGS. 9B-9C. In some embodiments the computing device may further calculate one or more of average intensity, maximum intensity, and most common intensity value from the y and z data sets.

The above-described systems and methods can be implemented in digital electronic circuitry, in computer hardware, firmware, and/or software. The implementation can be as a computer program product. The implementation can, for example, be in a machine-readable storage device, for execution by, or to control the operation of, data processing apparatus. The implementation can, for example, be a programmable processor, a computer, and/or multiple computers.

A computer program can be written in any form of programming language, including compiled and/or interpreted languages, and the computer program can be deployed in any form, including as a stand-alone program or as a subroutine, element, and/or other unit suitable for use in a computing environment. A computer program can be deployed to be executed on one computer or on multiple computers at one site.

Method steps can be performed by one or more programmable processors executing a computer program to perform functions of the invention by operating on input data and generating output. Method steps can also be performed by and an apparatus can be implemented as special purpose logic circuitry. The circuitry can, for example, be a FPGA (field programmable gate array) and/or an ASIC (application-specific integrated circuit). Subroutines and software agents can refer to portions of the computer program, the processor, the special circuitry, software, and/or hardware that implement that functionality.

Processors suitable for the execution of a computer program include, by way of example, both general and special purpose microprocessors, and any one or more processors of any kind of digital computer. Generally, a processor receives instructions and data from a read-only memory or a random access memory or both. The essential elements of a computer are a processor for executing instructions and one or more memory devices for storing instructions and data. Generally, a computer can include, can be operatively coupled to receive data from and/or transfer data to one or more mass storage devices for storing data (e.g., magnetic, magneto-optical disks, or optical disks).

Data transmission and instructions can also occur over a communications network. Information carriers suitable for embodying computer program instructions and data include all forms of non-volatile memory, including by way of example semiconductor memory devices. The information carriers can, for example, be EPROM, EEPROM, flash memory devices, magnetic disks, internal hard disks, removable disks, magneto-optical disks, CD-ROM, and/or DVD-ROM disks. The processor and the memory can be supplemented by, and/or incorporated in special purpose logic circuitry.

To provide for interaction with a user, the above-described techniques can be implemented on a computer having a display device. The display device can, for example, be a cathode ray tube (CRT) and/or a liquid crystal display (LCD) monitor. The interaction with a user can, for example, be a display of information to the user and a keyboard and a pointing device (e.g., a mouse or a trackball) by which the user can provide input to the computer (e.g., interact with a user interface element). Other kinds of devices can be used to provide for interaction with a user. Other devices can, for example, be feedback provided to the user in any form of sensory feedback (e.g., visual feedback, auditory feedback, or tactile feedback). Input from the user can, for example, be received in any form, including acoustic, speech, and/or tactile input.

The above-described techniques can be implemented in a distributed computing system that includes a back-end component. The back-end component can, for example, be a data server, a middleware component, and/or an application server. The above-described techniques can be implemented in a distributing computing system that includes a front-end component. The front-end component can, for example, be a client computer having a graphical user interface, a Web browser through which a user can interact with an example implementation, and/or other graphical user interfaces for a transmitting device. The components of the system can be interconnected by any form or medium of digital data communication (e.g., a communication network). Examples of communication networks include a local area network (LAN), a wide area network (WAN), the Internet, wired networks, and/or wireless networks.

The system can include clients and servers. A client and a server are generally remote from each other and typically interact through a communication network. The relationship of client and server arises by virtue of computer programs running on the respective computers and having a client-server relationship to each other.

Packet-based networks can include, for example, the Internet, a carrier internet protocol (IP) network (e.g., local area network (LAN), wide area network (WAN), campus area network (CAN), metropolitan area network (MAN), home area network (HAN)), a private IP network, an IP private branch exchange (IPBX), a wireless network (e.g., radio access network (RAN), 802.11 network, 802.16 network, general packet radio service (GPRS) network, HiperLAN), and/or other packet-based networks. Circuit-based networks can include, for example, the public switched telephone network (PSTN), a private branch exchange (PBX), a wireless network (e.g., RAN, bluetooth, code-division multiple access (CDMA) network, time division multiple access (TDMA) network, global system for mobile communications (GSM) network), and/or other circuit-based networks.

The transmitting device can include, for example, a computer, a computer with a browser device, a telephone, an IP phone, a mobile device (e.g., cellular phone, personal digital assistant (PDA) device, laptop computer, electronic mail device, smart phone), and/or other communication devices. The browser device includes, for example, a computer (e.g., desktop computer, laptop computer, smart phone) with a world wide web browser (e.g., Microsoft® Internet Explorer® available from Microsoft Corporation, Mozilla® Firefox available from Mozilla Corporation). The mobile computing device includes, for example, an iPhone®, Android® smart phone, and a Blackberry® to name a few.

Comprise, include, and/or plural forms of each are open ended and include the listed parts and can include additional parts that are not listed. And/or is open ended and includes one or more of the listed parts and combinations of the listed parts.

One skilled in the art will realize the invention may be embodied in other specific forms without departing from the spirit or essential characteristics thereof. The foregoing embodiments are therefore to be considered in all respects illustrative rather than limiting of the invention described herein. For instance, while examples of the measuring device, user device, and smart device are described with reference to the functional blocks of FIG. 2A and FIG. 2B, other examples of these devices can include more or fewer functional blocks. In another instance, while examples of the application are described with reference to the flowcharts of FIG. 5 and FIG. 7, other examples of the application may include more or fewer steps. Scope of the invention is thus indicated by the appended claims, rather than by the foregoing description, and all changes that come within the meaning and range of equivalency of the claims are therefore intended to be embraced therein.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. (canceled)

18. (canceled)

19. A system for measuring acceleration of an elevator component, comprising:
an adapter; and
a measuring device;
wherein the measuring device comprises an accelerometer configured to measure a frequency of acceleration of rope movement when at least a portion of a first rope is secured to the measuring device with the help of the adapter.

20. A system for measuring acceleration of an elevator component, comprising:
an adapter; and
a measuring device;
wherein the measuring device comprises an accelerometer configured to measure a frequency of acceleration of an elevator component when each of a first, a second, and a third leg of the adapter is in contact with a relatively horizontal surface of the elevator component and the measuring device is received within an opening of the adapter.

21. The system of claim 19, further comprising a computing device in communication with the measuring device;
wherein the computing device is configured to calculate at least one of the true rope tension and a value indicative of rope tension of the first rope based upon the frequency of acceleration measured by the accelerometer.

22. The system of claim 21, wherein the computing device is in communication with the measuring device at least partly via a wireless communications network.

23. The system of claim 21, wherein:
the measuring device is secured consecutively to at least a portion of the first rope and to at least a portion of a second rope;
the computing device is configured to calculate at least one of the true rope tension and a value indicative of rope tension based upon the frequency of acceleration measured by an accelerometer of the second rope; and
the computing device is configured to store for at least the first rope and second rope one of (a) the frequency of acceleration of the rope movement; (b) the true rope tension; and (c) a value indicative of rope tension based upon the frequency of acceleration measured by the accelerometer.

24. The system of claim 23, wherein the computing device is configured to calculate at least one of: (a) the sum of the true tensions for the first rope and the second rope; (b) a percent difference between the values indicative of the tension of the first rope and the second rope; and (c) a percent difference between the true tensions of the first rope and the second rope.

25. The system of claim 24, wherein the computing device is configured to display, by a display in communication with the computing device, at least one of (a) the true rope tension of the first rope and the second rope; (b) the value indicative of rope tension of the first rope and the second rope; (c) the sum of the true tensions for the first rope and the second rope; (d) a percent difference between the values indicative of the tension of the first rope and the second rope; and (e) a percent difference between the true tensions of the first rope and the second rope.

26. The system of claim 19, wherein the portion of the first rope is secured within a cavity of the adapter and the measuring device is received within an opening thereof.

27. The system of claim 19, wherein the adapter comprises:
an elongated body extending between first and second ends, the body including a rope mounting side and a device mounting side;
the rope mounting side having an open cavity extending between the first and second ends and dimensioned to receive at least a portion of the first rope;
the device mounting side having a pair of opposed flanges projecting outwards from the body, wherein an opening between the flanges is dimensioned to receive at least a portion of the acceleration measuring device therein;
a first securing mechanism adapted to reversibly secure the portion of the first rope positioned within the cavity in contact with at least a portion of a surface of the cavity such that the first rope is substantially inhibited from moving with respect to the adapter body; and
a second securing mechanism adapted to reversibly secure the portion of the acceleration measuring device positioned within the opening in contact with at least a portion of a surface of the opening such that the measurement device is substantially inhibited from moving with respect to the adapter body.

28. The system of claim 27, wherein the first securing mechanism comprises at least one magnet positioned at the rope mounting side for magnetically attaching the adapter to the first rope.

29. A method for measuring rope tension for measuring acceleration of an elevator component comprising:
providing a system for measuring acceleration of an elevator component, comprising:
an adapter; and
a measuring device;
wherein the measuring device comprises an accelerometer configured to measure a frequency of acceleration of rope movement when at least a portion of a first rope is secured to the measuring device with the help of the adapter;
securing the portion of the first rope to the measuring device with the help of the adapter;
exciting the first rope to create a movement of the first rope; and
measuring, by the acceleration measuring device, the frequency of acceleration of the first rope movement.

30. The method of claim 29, further comprising:
receiving, by a computing device in communication with the measuring device, the measured frequency of acceleration; and
calculating at least one of the true rope tension and the value indicative of rope tension based upon the measured frequency of acceleration.

31. The method of claim 30, wherein the computing device is in communication with the acceleration measuring device at least partly via a wireless communications network.

32. The method of claim 31, further comprising displaying, by a display in communication with the computing device, at least one of the true rope tension and the value indicative of rope tension.

33. The method of claim 29, further comprising steps:
removing the measuring device and the adapter from the portion of the first rope;
securing a portion of a second rope to the measuring device with the help of the adapter;
exciting the second rope to create a movement of the second rope;
measuring, by the acceleration measuring device, the frequency of acceleration of the second rope movement;
calculating at least one of the true rope tension and the value indicative of rope tension based on the measured frequency of acceleration of the second rope; and
calculating at least one of: (a) the sum of the true tensions for the first rope and the second rope; (b) a percent difference between the values indicative of the tension of the first rope and the second rope; and (c) a percent difference between the true tensions of the first rope and the second rope.

34. The method of claim 33, further comprising:
displaying, by a display in communication with the computing device, at least one of (a) the true rope tension of the first rope and the second rope; (b) the value indicative of rope tension of the first rope and the second rope; (c) the sum of the true tensions for the first rope and the second rope; (d) a percent difference between the values indicative of the tension of the first rope and the second rope; and (e) a percent difference between the true tensions of the first rope and the second rope.
